(19) United States
(12) Patent Application Publication
(10) Pub. No.: US 2014/0172976 A1
(43) Pub. Date: Jun. 19, 2014

(54) SYSTEM AND METHOD FOR PROVIDING PERSONALIZABLE COMMUNICATION GROUP FUNCTIONS

(71) Applicant: Kristin F. Kocan, Warrenville, IL (US)

(72) Inventor: Kristin F. Kocan, Warrenville, IL (US)

(21) Appl. No.: 13/719,980

(22) Filed: Dec. 19, 2012

(51) Int. Cl. H04L 29/06

(52) U.S. Cl. CPC H04L 65/403
USPC 709/204

(57) ABSTRACT

A method and system for providing personalized communication group functions is provided. The method and system use a communication group platform that receives and acts on configuration requests and direction requests to provide customized communication service.

### TECHNICAL FIELD

The presently described embodiments relate to a system and method for providing personalizable communication group functions.

### BACKGROUND

End users of communication systems typically need quick and simple ways to manage combinations of communication events with groups of people in a personalized manner. The need includes setting up particular communication events (e.g., a conference call), desired actions during a particular communication event (e.g., sending information to participants during a conference call), and/or desired action or information collection following a communication event (e.g., sending follow-up information to participants). In addition, a variety of communication devices with a range of capabilities may need to be accommodated and leveraged (e.g., work phones that do not use Short Message Service (SMS), video-capable devices, smart mobile phones, work phones in conjunction with Personal Computers) in these environments.

Presently, combinations of services are used that are individually accessed and triggered by users, e.g., conference services combined with sharing systems such as LiveMeeting and email. There are desk-top tools available (e.g., with expensive collaboration systems that normally work only with group endpoints) to pull such services together to make them easier to use. These, however, do not provide personalized ease of use. They do not pull together device capabilities for the participants to adjust information dissemination. They do not make use of network resources to take advantage of location information. They do not take adequate advantage of advanced user equipment such as smart phones.

### SUMMARY

In one aspect of the presently described embodiments, a system comprises a configuration component configured to receive configuration requests, the configuration requests establishing and configuring communication groups of participants (which could be persons or resources), parameters associated with the groups and communication sessions involving the groups, and a direction component configured to receive direction requests, the direction requests determining actions and states of the communication sessions involving the communication groups.

In another aspect of the presently described embodiments, the configuration requests facilitate establishing and configuring a list of a group of participants.

In another aspect of the presently described embodiments, the configuration requests facilitate adding or deleting participants from the list.

In another aspect of the presently described embodiments, the configuration requests facilitate configuring properties of a communication session.

In another aspect of the presently described embodiments, the properties include types of events and properties associated with the types of events.

In another aspect of the presently described embodiments, the properties include time related properties.

In another aspect of the presently described embodiments, the properties include operations and properties associated with operations.

In another aspect of the presently described embodiments, the direction requests initiate a communication session.

In another aspect of the presently described embodiments, the direction requests initiate sending alerts to participants not active in the communication session.

In another aspect of the presently described embodiments, the direction requests initiate a process to track identity of participants active in the communication session.

In another aspect of the presently described embodiments, the direction requests initiate a process to obtain or maintain information on participants in the communication session including device capability information, location information or personal information.

In another aspect of the presently described embodiments, the direction requests initiate sending information to participants in a communication session.

In another aspect of the presently described embodiments, the direction requests enable control of communication parameters for participants in a communication session.

In another aspect of the presently described embodiments, a method comprises receiving configuration requests to establish and configure communication groups of participants (which could be persons or resources), parameters associated with the groups and communication sessions involving the groups, and receiving direction requests to determine actions and states of the communication sessions involving the communication groups.

In another aspect of the presently described embodiments, the configuration requests facilitate establishing and configuring a list of a group of participants.

In another aspect of the presently described embodiments, the configuration requests facilitate adding or deleting participants from the list.

In another aspect of the presently described embodiments, the configuration requests facilitate configuring properties of a communication session.

In another aspect of the presently described embodiments, the properties include types of events and properties associated with the types of events.

In another aspect of the presently described embodiments, the properties include time related properties.

In another aspect of the presently described embodiments, the properties include operations and properties associated with operations.

In another aspect of the presently described embodiments, the direction requests initiate a communication session.

In another aspect of the presently described embodiments, the direction requests initiate sending alerts to participants not active in the communication session.

In another aspect of the presently described embodiments, he direction requests initiate a process to track identity of participants active in the communication session.

In another aspect of the presently described embodiments, the direction requests initiate a process to obtain or maintain information on participants in the communication session including device capability information, location information or personal information.

In another aspect of the presently described embodiments, the direction requests initiate sending information to participants in a communication session.

In another aspect of the presently described embodiments, the direction requests enable control of communication parameters for participants in a communication session.

Further scope of the applicability of the presently described embodiments will become apparent from the detailed description provided below. It should be understood, however, that the detailed description and specific examples, while indicating some embodiments, are given by way of illustration only, since various changes and modifications within the spirit and scope of this description will become apparent to those skilled in the art.

### DESCRIPTION OF THE DRAWINGS

Some embodiments of systems and/or methods in accordance with the present disclosure are now described, by way of example only, and with reference to the accompanying drawings in which:

FIG. 1 is an illustration of a system according to the presently described embodiments;

FIG. 2 is an illustration of a system according to the presently described embodiments; and

FIG. 3 is a call flow according to the presently described embodiments.

### DETAILED DESCRIPTION

The presently described embodiments provide a system and method allowing a single platform user to manage combinations of communication events involving groups of people in a personalized manner. The presently described embodiments, in doing so, facilitate personalized ease of use, gather and maintain information on device capabilities of the participants (which could be persons or resources) to selectively adjust information dissemination, take advantage of such device capabilities, and use network resources to take advantage of network information (such as location information).

More particularly, according to the presently described embodiments, a network platform, e.g., a communication group platform, is utilized to provide a personalized or configured group communication environment. This platform has access to network resources and other resources (e.g., call control, SMS and other messaging, web socket connectivity, email, location, available web services), and components (e.g., services and enablers) that are personalizable by end users. These components retain information concerning communication groups configured by end users. These components obtain information periodically, per call, or per other event (e.g., request) as configured by the end user. Such information can be location, device capabilities, device options, information gathered from network address books, and information taken from web services that relate to those in a group, or those who are active in a group (e.g., on a conference call together). An associated configuration application can be used that runs on end user equipment, such as a PC or smart phone having widgets and/or voice instruction recognition, for configuring the network-based components. This application that may be provided to end users for configuring the network-based components could take a variety of forms. It may be a Java application for the PC, a Java application for Android smart phones, and/or applications written in appropriate languages for iPhones, Blackberry smart phones, etc.

In one example, a platform according to the presently described embodiments may be implemented as a part of the Service Composition Framework (SCF) of the Open API Platform (OAP) of Alcatel-Lucent's Application Enablement (AE) offering. The SCF allows for programmable components. The components, in the case of the presently described embodiments, would include enabler components to access each network or other resource involved, and a service component that can be configured as a result of requests (e.g., either REST requests or web socket requests) received from end users. The service component may further include a configuration component and/or a direction component, as will be described. These are just examples. It should be appreciated that the contemplated platform may take a variety of forms including suitably programmed hardware and/or processors that execute routines and/or process data in accord with the presently described embodiments.

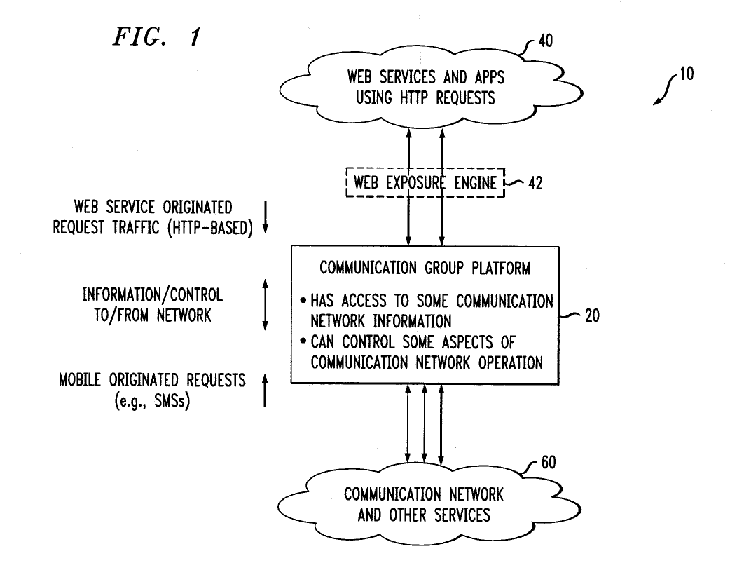

Referring now to the drawings wherein the showings are for purposes of illustrating the exemplary embodiments only and not for purposes of limiting the claimed subject matter, FIG. 1 provides a view of a system into which the presently described embodiments may be incorporated. As shown generally, FIG. 1 includes a network 10 into which the presently described embodiments are implemented in an exemplary manner. The network 10 includes a communication group platform element 20, web services and apps components 40 (optionally utilizing a web exposure engine 42) and a communication network 60. As shown, the communication group platform element 20 is operative and configured to receive web service originated request traffic (e.g., HTTP-based) from the web services and apps components 40, and mobile originated requests (e.g., SMS . . . etc.) from the communication network 60. The communication group platform element 20 is also operative and configured to exchange information and control features with both the components 40 and network 60. As such, the element 20 has access to communication network information, and can control aspects of communication network operation.

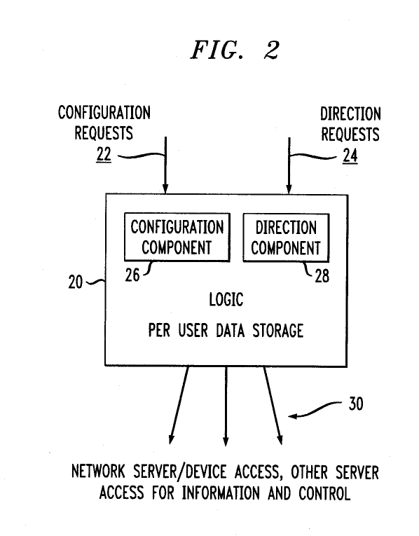

With reference to FIG. 2, the communication group platform element 20 is shown in greater detail. In this regard, the element 20 is configured and operative to receive configuration requests 22 and direction requests 24. To do so, a configuration component 26 and a direction component 28 are provided. The configuration requests 22 are recognized by the configuration component 26 of the communication group platform element 20, and allow a user to set-up and configure groups of participants and communication sessions for such participants. The direction requests are recognized by the direction component 28 of the communication group platform element 20, and determine actions and states for a communication session. The communication group platform element 20 also is operative to send or transmit data and/or messages 30 to network destinations in a variety of manners to achieve functionality contemplated by the presently described embodiments.

Configuration requests 22 allow for a variety of functions to set-up and maintain the communication group platform element 20. Examples of such configuration-related user operations prompted by configuration requests include:

1) establishing communication groups,

2) configuring a list of participants for a communication group (participants can be persons or resources),

3) adding or deleting from the list of participants, and

4) configuring communication group properties for the communication groups which will include event type and properties associated with the event type, can include times-of-day, other time-related properties and can include operations and parameters associated with operations (e.g., phone numbers, email addresses, urls, etc.).

Direction requests 24 allow for a variety of event-related activities to be initiated. Examples of such event-related user operations enabled or initiated by the direction requests include:

1) starting a communication event (e.g., a call to everyone in a Communication group,)

2) sending alert to those in the group who are not active in the event,

3) keeping track of who is active in the event,

4) obtaining/maintaining information pertaining to everyone active in the event such as device capability information, location information, and personal information (requires opt-in),

5) sending information to everyone active in the event specific to device in use during or after event (e.g., SMS, HTML-5 push, email, etc.),

6) obtaining/maintaining location information of everyone active in the event, and

7) controlling communication aspects of those active in the event (e.g., could be QoS pipe control for video, large data, or other large content).

Behavior of the communication group platform element 20 depends on state (which may be static or transient) and directions. Static states are the results of the communication group platform user configuring the communication groups. Operations that determine static states are configuration-related user operations. The number of static states is not inherently limited and the states will be configuration-dependent.

A static state is specific to each communication group and is personally configured by the communication group platform user. The communication group platform user establishes and configures communication groups (which can be multiple). The communication group platform user configures parameters associated with the groups, which may include participants, times (e.g., start and end times), dates, event type (e.g., call, info sharing, gaming, etc.).

Transient states are the results of event-related user operations and event-related information acquisition. Operations that affect transient states are event-related operations. The duration of transient states is, at most, the duration of an event.

A transient state is specific to each communication group during an event and is determined by event-related operations or event-related activity. The communication group platform user may direct event-related state change via operations. Some parameters associated with groups/participants may be given values via acquisition (meaning as a side-effect of communication group platform operations) (e.g., whether the participant is active, participant device capabilities for devices in use, location of each participant, etc.).

Directions originate from the communication group platform user and are sent to the communication group platform element 20 to configure the above-noted states. The communication group platform element 20 works by accepting requests (e.g., HTTP requests). The requests carry state configuration instructions (e.g., via XML or JSON).

Directions also originate from the communication group platform user and are sent to the communication group platform element 20 to initiate event-related activity. This is accomplished via requests sent from the end user (e.g., a PC or smart phone) to the communication group platform element 20. The requests carry directions for initiating communication activity or some other activity, such as “contact the Google weather website and initiate the communication activity if the temperature is above 85 F” (e.g., via XML or JSON).

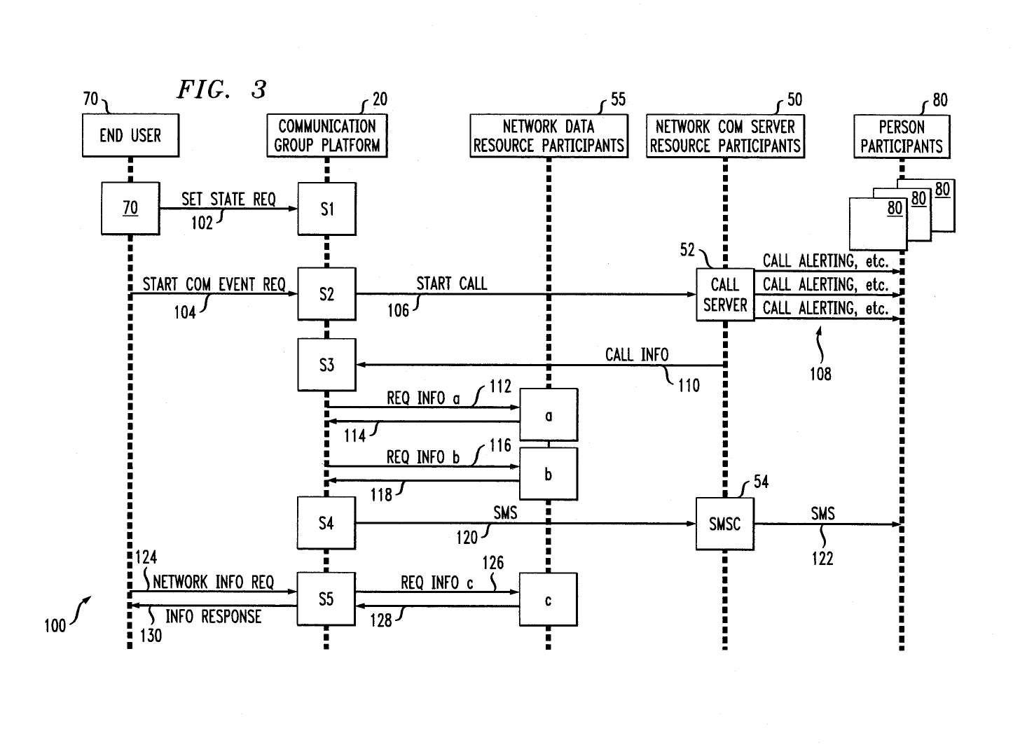

With reference now to FIG. 3, an example call flow is illustrated. It should be understood that this call flow is only exemplary to illustrate a few features of the presently described embodiments, and is not intended to be limiting. It should be also understood that, as noted above, participants could take a variety of forms, including persons or resources, as is illustrated in the following example.

As shown, a communication group platform user 70 configures communication group platform element 20 to know about a specific communication group with a list of desired participants including person participants 80 (at 102). The communication group platform state for this user changes to S1. The communication group platform element 20 keeps the per-user data in a database.

The communication group platform user 70 initiates a communication event (in this case, a call) for the group. The communication group platform element 20 uses third party call control to start (at 104/106) a conference call via a next generation call server 52 among the network communication server resource participants 50 in the network, and alerts are transmitted to the person participants 80 (at 108). The communication group platform state for this user changes to S2.

The communication group platform element 20 receives call info from the call server (at 110). A response from the call server changes the communication group platform state to S3. The response indicates that a desired participant has not been connected.

The communication group platform element 20 then accesses participant information (as it was configured to do) using network data resource participants 55 (at 112-118). The communication group platform state for this user changes to S4. The communication group platform element 20 generates an SMS to the person participant that has not been connected (as it was configured to do) (at 120/122).

The communication group platform user 70 also may initiate a request for location information of the participants (at 124). The communication group platform element 20 accesses location information—this could be from various network data resource participants 55 including from GMLS, from GPS information, or from other address information for those in their office or homes (at 126/128). The communication group platform element 20 responds with the information (e.g., in a web page format), or with an HTML-5 push (at 130).

Benefits of the presently described embodiments include 1) ease of configuring desired repetitive action (actions that can be repeated for various communication events), 2) use of a range of actions that can be automatically triggered (such as sending SMSs to all active participants in a communication event), and 3) use of network-based information to tailor actions (such as sending email instead of an SMS to a participant on a work phone—no SMS—but with a PC, where the network information includes device used and device capability information).

A person of skill in the art would readily recognize the steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices maybe, e.g., digital memories, magnetic storage media such as magnetic disks and magnetic tapes, hard drives, or optically readable digital data storage media. The embodiments are also intended to cover computers programmed to perform said steps of the above-described methods.

It should also be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The above description merely provides a disclosure of particular embodiments and is not intended for the purposes of limiting the same thereto. As such, it is not limited to only the above-described embodiments. Rather, it is recognized that one skilled in the art could conceive alternative embodiments that fall within the scope hereof.

We claim:

1. A system comprising:
a configuration component configured to receive configuration requests, the configuration requests establishing and configuring communication groups of participants, parameters associated with the groups and communication sessions involving the groups; and
a direction component configured to receive direction requests, the direction requests determining actions and states of the communication sessions involving the communication groups.

2. The system according to claim 1 wherein the configuration requests facilitate establishing and configuring a list of a group of participants.

3. The system according to claim 2 wherein the configuration requests facilitate adding or deleting participants from the list.

4. The system according to claim 1 wherein the configuration requests facilitate configuring properties of a communication session.

5. The system according to claim 4 wherein the properties include types of events and properties associated with the types of events.

6. The system according to claim 4 wherein the properties include time related properties.

7. The system according to claim 4 wherein the properties include operations and properties associated with operations.

8. The system according to claim 1 wherein the direction requests initiate a communication session.

9. The system according to claim 1 wherein the direction requests initiate sending alerts to participants not active in the communication session.

10. The system according to claim 1 wherein the direction requests initiate a process to track identity of participants active in the communication session.

11. The system according to claim 1 wherein the direction requests initiate a process to obtain or maintain information on participants in the communication session including device capability information, location information or personal information.

12. The system according to claim 1 wherein the direction requests initiate sending information to participants in a communication session.

13. The system according to claim 1 wherein the direction requests enable control of communication parameters for participants in a communication session.

14. A method comprising:
receiving configuration requests to establish and configure communication groups of participants, parameters associated with the groups and communication sessions involving the groups; and
receiving direction requests to determine actions and states of the communication sessions involving the communication groups.

15. The method according to claim 14 wherein the configuration requests facilitate establishing and configuring a list of a group of participants.

16. The method according to claim 15 wherein the configuration requests facilitate adding or deleting participants from the list.

17. The method according to claim 14 wherein the configuration requests facilitate configuring properties of a communication session.

18. The method according to claim 17 wherein the properties include types of events and properties associated with the types of events.

19. The method according to claim 17 wherein the properties include time related properties.

20. The method according to claim 17 wherein the properties include operations and properties associated with operations.

21. The method according to claim 14 wherein the direction requests initiate a communication session.

22. The method according to claim 14 wherein the direction requests initiate sending alerts to participants not active in the communication session.

23. The method according to claim 14 wherein the direction requests initiate a process to track identity of participants active in the communication session.

24. The method according to claim 14 wherein the direction requests initiate a process to obtain or maintain information on participants in the communication session including device capability information, location information or personal information.

25. The method according to claim 14 wherein the direction requests initiate sending information to participants in a communication session.

26. The method according to claim 14 wherein the direction requests enable control of communication parameters for participants in a communication session.
